(19) United States
(12) Patent Application Publication
(10) Pub. No.: US 2014/0231662 A1
(43) Pub. Date: Aug. 21, 2014

(54) RADIATION IMAGING APPARATUS AND METHOD OF CONTROLLING RADIATION IMAGING APPARATUS

(71) Applicant: CANON KABUSHIKI KAISHA, Tokyo (JP)

(72) Inventor: Masaaki Kobayashi, Shimotsuke-shi (JP)

(73) Assignee: CANON KABUSHIKI KAISHA, Tokyo (JP)

(21) Appl. No.: 14/164,881

(22) Filed: Jan. 27, 2014

(30) Foreign Application Priority Data
Feb. 18, 2013 (JP) 2013-029436

(51) Int. Cl. G01T 1/17

(52) U.S. Cl. CPC G01T 1/17
USPC 250/394

(57) ABSTRACT

A radiation imaging apparatus includes: a radiation imaging unit configured to include a housing and a detection unit having a rectangular imaging region, the detecting unit being placed at a position in the housing at which a distance from one side surface of the housing to the imaging region is shorter than a distance from another side surface to the imaging region; a rotating unit configured to rotate the radiation imaging unit about a rotation axis in a direction intersecting with the imaging region; and a control unit configured to control rotation of the rotating unit so as to orientate one side surface of the housing, a distance from which to the imaging region is short, to a direction corresponding to an imaging condition.

### BACKGROUND OF THE INVENTION

1. Field of the Invention

The present invention relates to a radiation imaging apparatus using a radiation detection panel which converts radiation into an electrical signal in accordance with the intensity of the radiation and a method of controlling the radiation imaging apparatus.

2. Description of the Related Art

Recently, a digital radiation imaging apparatus which directly digitizes a radiation image by using a radiation detection panel having a phosphor tightly attached to a large-area solid-state image sensor has been put into practice and widely used in place of conventional analog imaging apparatuses. The digital radiation imaging apparatus using the radiation detection panel can instantly obtain a radiation image as digital information, thus having many merits such as promoting labor saving in imaging operation by a technician and improving the efficiency of interpretation of radiation images by a doctor.

As the internal structure of a radiation imaging unit as the image obtaining unit of such a digital radiation imaging apparatus, there is known an arrangement in which a radiation detection panel is incorporated in a housing while being held by a supporting member (see patent literature 1: Japanese Patent No. 4393528).

As shown in FIG. 1 of patent literature 1, flexible printed circuit boards (FPCs) 27 are respectively connected to two ends of an X-ray image detection panel (to be referred to as a radiation detection panel) 24 to send signals for driving the radiation detection panel 24 and extract signals obtained by the radiation detection panel 24. Connection electrodes 26 for connecting the FPCs 27 are provided outside the imaging region on the radiation detection panel 24. The FPCs 27 connected to the connection electrodes 26 pass between the radiation detection panel 24 and the inner wall of a housing 21 and are connected to circuit boards 28 and 29 arranged at the back.

The imaging region on the radiation detection panel 24 is located inside the connection electrodes 26. For this reason, the outer wall of the housing 21 and the imaging region have a certain distance between them, which is required for the thickness of the housing side surface, a layout space for the FPC between the housing inner wall and the panel, and the connection electrodes 26 on the radiation detection panel 24.

On the other hand, such a radiation imaging unit is mounted for imaging operation on an upright stand or photography apparatus in accordance with an imaging purpose. In addition, there is proposed an imaging apparatus which includes a holding portion holding a radiation imaging unit and an X-ray tube unit so as to make them face each other and can image an object from various directions by changing the position of the holding portion (patent literature 2: Japanese Patent Laid-Open No. 11-226001 to be referred to as related art 1).

The imaging apparatus disclosed in patent literature 2 can perform imaging while an end portion of the radiation imaging unit is positioned near an object by moving the holding portion which holds the radiation imaging unit. In this case, since the distance from a side surface of the housing of the radiation imaging unit to the imaging region is short in a planar direction parallel to the radiation incident plane, it is possible to place the radiation imaging unit at a position nearer to a portion to be examined. In this case, a side surface of the housing, the distance from which to the imaging region is short will be referred to as a narrow frame edge. When the radiation imaging unit is placed slightly away from an object, a narrow frame edge can ensure a wider gap between the object and the radiation imaging unit. This makes it possible to reduce an oppressive feeling for the object.

FIG. 9 is a view showing a state in which a radiation imaging unit 2 is mounted on an upright stand 1. In simple chest radiography, the apparatus images an object P while the chin is rested on the side surface of an upper portion of the radiation imaging unit 2. Reference symbol A denotes the imaging region of the radiation imaging unit 2. When imaging the lungs of the object P up to their upper ends (lung apexes), a distance L1 from the side surface of the upper portion of the radiation imaging unit 2 to the imaging region A is short, that is, the upper portion is a narrow frame edge (which will be referred to as related art 2). Although the FPCs 27 are arranged on all the four sides of the radiation detection panel 24 as shown in FIG. 3 of patent literature 1, a radiation detection panel provided with sides to which no FPCs are connected has recently been developed as a result of improving the radiation detection panel. The sides of the radiation detection panel to which no FPCs are connected require no connection electrode (for example, the connection electrodes 26 in FIG. 1 of patent literature 1) formed on an end portions of the radiation detection panel. In addition, since there is no need to ensure spaces for FPCs, it is easy to form the housing into a structure with narrow frame edges. However, it is not possible to avoid the connection of FPCs to all the sides, and a radiation detection panel having a driving FPC and a reading FPC respectively arranged on two adjacent sides has generally been put into practice. When using such a radiation detection panel, a housing side surface corresponding to a side to which no FPC is connected becomes a frame edge narrower than a housing side surface corresponding to a side to which an FPC is connected. This makes it possible to provide a radiation imaging unit whose four side surfaces include side surfaces with short frame edges.

In addition, as another arrangement configured to provide a radiation imaging unit having narrow frame edges, patent literature 3 (Japanese Patent Laid-Open No. 2002-143138) discloses an arrangement (to be referred to as related art 3) configured to form narrow frame edges by moving an internal structure holding a radiation detection panel inside a housing. The related art described above has the following problem. When considering a structure having narrow frame edges, a radiation imaging unit having a rectangular parallelepiped housing has side surfaces with different lengths (frame edge lengths) from the side surfaces of the housing to an effective imaging region.

For example, an imaging apparatus mounted on a C-arm like that disclosed in related art 1 gives no consideration to a radiation imaging unit with different frame edge lengths or no consideration to an imaging technique effectively using narrow frame edges.

In addition, it is also difficult for a radiation imaging unit with the position of a narrow frame edge being fixed to an upper position as in related art 2 to have a narrow frame edge at a lower position in consideration of the arrangement of FPCs on a radiation detection panel. This makes it impossible to cope with an imaging mode requiring a narrow frame edge at a lower position when, for example, imaging different imaging portions in an object while he/she is in a sitting position.

On the other hand, according to the arrangement of related art 3, the position of a narrow frame edge can be changed by moving the radiation detection panel inside the housing. As described above, however, the length of a narrow frame edge formed after the panel moves to the maximum extent depends on the connected state of an FPC of the radiation detection panel accommodated in the housing, and hence provides no solution to a situation in which narrow frame edges differ in length at the locations on a housing side surface. That is, it is not possible to effectively use a narrow frame edge as much as possible, that is, it is not possible to perform imaging while positioning a narrow frame edge in a direction corresponding to imaging conditions.

### SUMMARY OF THE INVENTION

The present invention provides a radiation imaging technique which can easily perform imaging while positioning a narrow frame edge of a radiation imaging unit in a direction corresponding to imaging conditions.

According to one aspect of the present invention, there is provided a radiation imaging apparatus comprising: a radiation imaging unit configured to have different frame edge widths from side surfaces to an imaging region; a rotating unit configured to rotate the radiation imaging unit about a rotation axis in a direction perpendicular to the imaging region; and a control unit configured to control rotation of the rotating unit so as to place a side surface at which the frame edge width is small at a predetermined position in accordance with a position of the radiation imaging unit.

According to another aspect of the present invention, there is provided a radiation imaging apparatus comprising: a radiation imaging unit configured to have different frame edge widths from side surfaces to an imaging region; a rotating unit configured to rotate the radiation imaging unit about a rotation axis in a direction perpendicular to the imaging region; and a control unit configured to control rotation of the rotating unit so as to place a side surface at which the frame edge width is small at a predetermined position in accordance with an imaging method for the object.

According to still another aspect of the present invention, there is provided a radiation imaging apparatus comprising: a radiation imaging unit configured to include a housing and a detection unit having a rectangular imaging region, the detecting unit being placed at a position in the housing at which a distance from one side surface of the housing to the imaging region is shorter than a distance from another side surface to the imaging region; a rotating unit configured to rotate the radiation imaging unit about a rotation axis in a direction intersecting with the imaging region; and a control unit configured to control rotation of the rotating unit so as to orientate one side surface of the housing, a distance from which to the imaging region is short, to a direction corresponding to an imaging condition.

Further features of the present invention will become apparent from the following description of exemplary embodiments (with reference to the attached drawings).

### BRIEF DESCRIPTION OF THE DRAWINGS

FIG. 1 is a view showing the internal structure of the radiation imaging unit of a radiation imaging apparatus according to the first embodiment when viewed from a side;

FIG. 2 is a view showing the internal structure of the radiation imaging unit of the radiation imaging apparatus according to the first embodiment when viewed from a front side;

FIG. 3 is a view showing the overall arrangement of the radiation imaging apparatus according to the first embodiment;

FIGS. 4A and 4B are views for explaining the operation of the radiation imaging apparatus according to the first embodiment;

FIGS. 5A to 5C are views for explaining the arrangement and operation of a radiation imaging apparatus according to the second embodiment;

FIG. 6 is a view showing the internal structure of the radiation imaging unit of a radiation imaging apparatus according to the third embodiment when viewed from a front side;

FIGS. 7A to 7C are views for explaining the arrangement and operation of a radiation imaging apparatus according to the third embodiment;

FIGS. 8A to 8C are views for explaining the arrangement and operation of a radiation imaging apparatus according to the fourth embodiment; and

FIG. 9 is a view showing an example of the arrangement of a conventional radiation imaging apparatus.

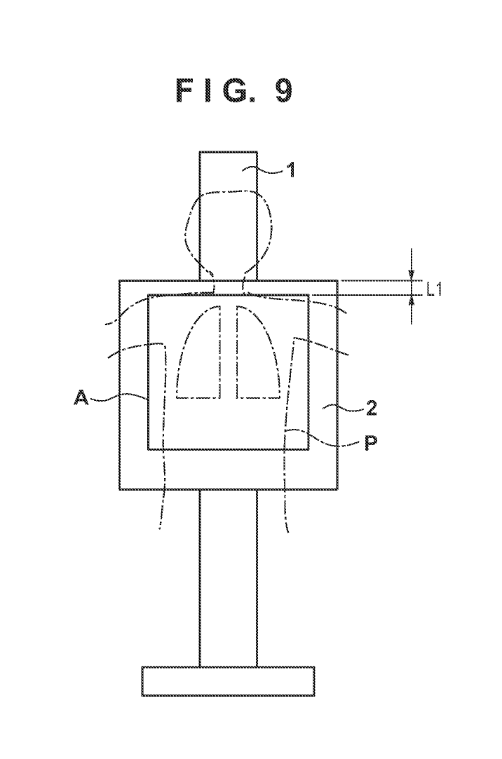

### DESCRIPTION OF THE EMBODIMENTS

Embodiments of the present invention will be exemplarily described in detail below with reference to the accompanying drawings. Note that the constituent elements described in the embodiments are merely examples. The technical scope of the present invention is determined by the scope of claims and is not limited by the following individual embodiments.

### First Embodiment

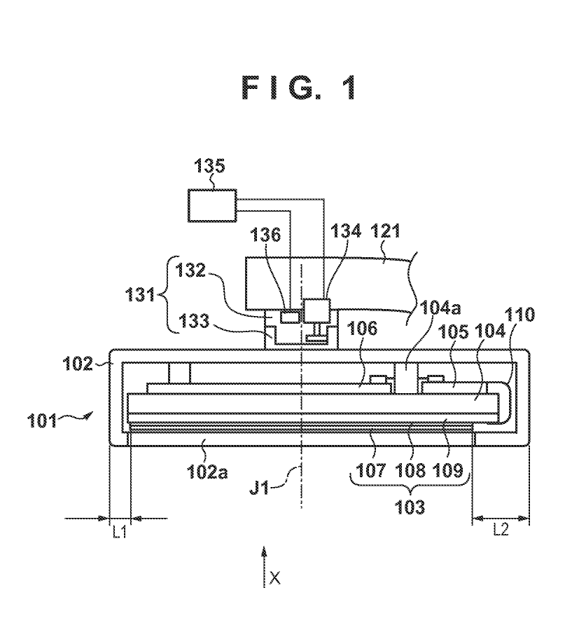

FIG. 1 is a view showing the internal structure of a radiation imaging unit as an example of the arrangement of a radiation imaging apparatus according to the first embodiment when viewed from a side. A radiation imaging unit 101 includes a radiation detection panel 103 (detection unit), a supporting member 104, and circuit boards 105 and 106, which are accommodated in a housing 102. The supporting member 104 is a panel supporting structure which supports the radiation detection panel 103, and includes a plurality of leg portions 104a on a surface on the opposite side to the surface which supports the radiation detection panel 103. The leg portions 104a are joined to the inner wall of the housing 102.

The radiation detection panel 103 having a rectangular imaging region A is arranged at a position in the housing 102 at which the distance from one side surface (for example, one of side surfaces S1 and S2) of the housing 102 to the imaging region A is shorter than the distance from another side surface (for example, one of side surfaces S3 and S4) of the housing 102 to the imaging region A.

The radiation detection panel 103 is obtained by stacking a phosphor 107 which converts radiation entering from the X direction into visible light, photoelectric conversion elements 108 arranged in a lattice pattern and configured to convert converted visible light into an electrical signal, and a glass substrate 109 which supports the photoelectric conversion elements 108. A flexible printed circuit board (FPC) 110 is connected to the right side end portion of the glass substrate 109. The other end of the FPC 110 is connected to the circuit board 105 arranged in the gap provided between the supporting member 104 and the housing 102 by the leg portions 104a. In addition, a radiation incident portion 102a of the housing 102 is formed from a CFRP member or the like which absorbs a small amount of radiation.

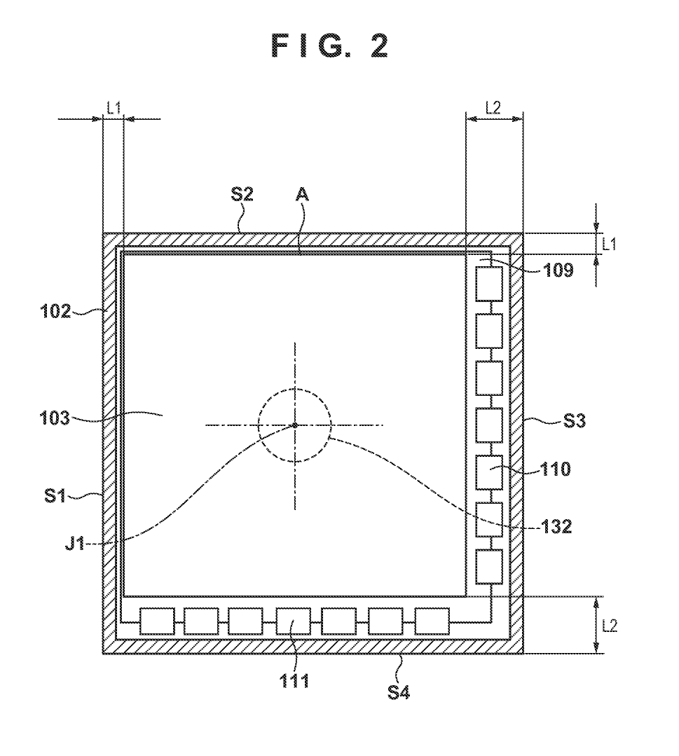

FIG. 2 is a view showing the internal structure of the radiation imaging unit 101 in FIG. 1 when viewed from the X direction (front surface). Referring to FIG. 2, a sectional shape of the housing 102 is indicated by the hatched portion, and has the four side surfaces S1 to S4 when viewed from the radiation incident plane (X direction). On the radiation detection panel 103, the imaging region A which can obtain a radiation image is a rectangular region. Note that the imaging region A of the radiation detection panel 103 described with reference to FIG. 2 has a square imaging region having equal adjacent sides. The third embodiment will exemplify a case in which a radiation detection panel 103 has a rectangular imaging region having different adjacent sides.

The FPC 110 and an FPC 111 are respectively connected to the right end side surface and lower end side surface of the glass substrate 109. No FPCs are connected to the remaining two sides. At the two sides to which the FPCs are connected, the distances from end portions of the glass substrate 109 to the imaging region A are longer than those at the sides having no FPCs, because the glass substrate 109 has connection electrodes for the connection of the FPCs outside the imaging region A. At the two sides to which the FPCs are connected, spaces for routing the FPCs are required between the end portions of the glass substrate 109 and the inner wall of the housing 102. Assume that the frame edge lengths at the side surfaces S1 and S2 of the housing 102 are a same length L1 because almost the same members are interposed between the housing 102 and the glass substrate 109. Assume that the frame edge lengths at the side surfaces S3 and S4 are a length L2. In this case, the relationship of L1<L2 holds because of the presence/absence of connection electrode portions and the difference originating from the arrangement spaces for the FPCs. That is, the distance (L1) from at least one side surface of the housing 102 to the imaging region A within a plane parallel to the imaging region A is shorter than the distance (L2) from another side surface of the housing 102 to the imaging region A.

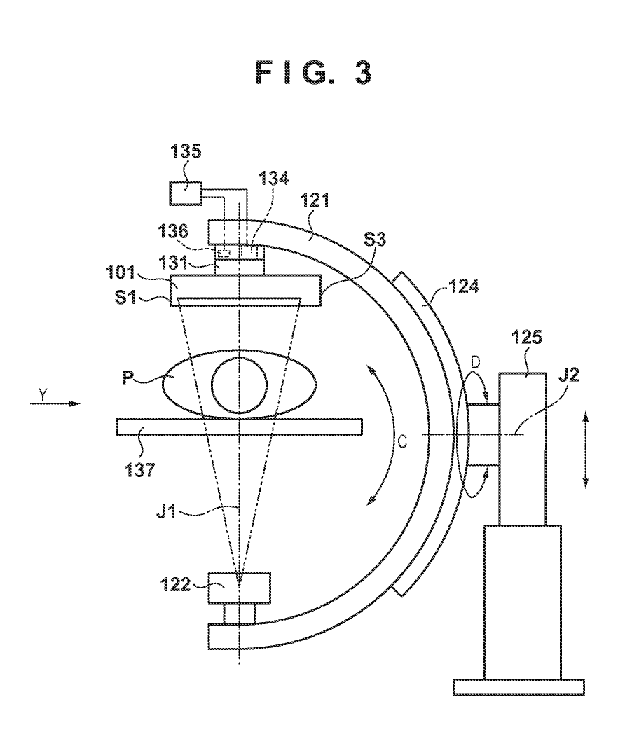

FIG. 3 is a view showing the overall arrangement of the radiation imaging apparatus according to the first embodiment and an example of the arrangement of a supporting structure which supports the radiation imaging unit and the X-ray tube. The radiation imaging unit 101 is supported on one end of a supporting arm 121 having a C shape. An X-ray generation unit 122 such as an X-ray tube and the radiation imaging unit 101 are supported on the end portion of the modem 121 on the opposite side so as to face each other. In addition, an arm holder 124 holds the supporting arm 121. The arm holder 124 has a function of sliding the supporting arm 121 in a direction (C direction) along an arcuated shape.

A base portion 125 holds the arm holder 124. The base portion 125 has a rotating mechanism for rotating the arm holder 124 in the D direction about a rotation axis J2. In addition, the base portion 125 incorporates an elevating mechanism which can change the height from the floor to the supporting arm 121 by moving it up and down.

The supporting arm 121 allows to image an object P from an arbitrary direction while keeping the radiation imaging unit 101 and the X-ray generation unit 122 to face each other by combining sliding operation in the C direction with vertical movement performed by rotation in the D direction and elevating operation.

A rotating mechanical unit 131 is provided at the connecting portion between the radiation imaging unit 101 and the supporting arm 121. As shown in FIG. 1, the rotating mechanical unit 131 has a rotating portion 133 attached to the radiation imaging unit 101 and rotatably connected to a fixed portion 132 fixed to the supporting arm 121. A rotation axis J1 of the rotating mechanical unit 131 is in a direction (vertical direction) intersecting with an imaging plane of the radiation imaging unit 101, and is positioned to pass through the center of the imaging region A, as shown in FIG. 2. In addition, the rotation axis J1 coincides with the optical axis of the X-ray generation unit 122.

A rotation driving unit 134 including a motor and a driver which drives the motor drives the rotating mechanical unit 131. A rotation control unit 135 controls this operation. The apparatus includes, near the rotating mechanical unit 131, a tilt detection unit 136 which measures the tilt state of the radiation imaging unit 101. The tilt detection unit 136 transmits a detection result to the rotation control unit 135.

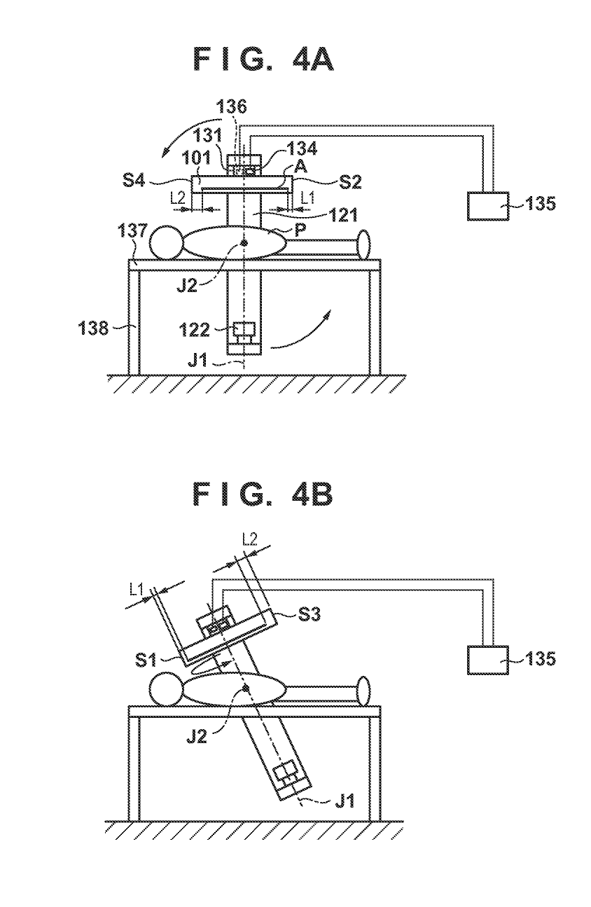

FIGS. 4A and 4B are views showing the arrangement in FIG. 3 when viewed from the Y direction. The operation of each unit at the time of imaging by the radiation imaging apparatus will be described with reference to FIGS. 4A and 4B. Referring to FIGS. 4A and 4B, the object P is lying on a top 137. The top 137 is supported on the floor through a leg portion 138. Note that this embodiment provides the elevating mechanism for the base portion 125 but may provide the leg portion 138 in place of the base portion 125.

The initial position of each constituent element of the radiation imaging apparatus can be set to an arbitrary position. For the sake of descriptive convenience, however, assume that each position in the state shown in FIG. 4A is the initial position. In the state shown in FIG. 4A, the X-ray generation unit 122 and the radiation imaging unit 101 are respectively located at lower and upper positions, and the side surface S2 as a narrow frame edge of the radiation imaging unit 101 is located on the right side. The arrangement in this state is changed to an arrangement to obtain a transmission image by irradiating the object P from diagonally downward right. The apparatus tilts the rotation axis J1 connecting the X-ray generation unit 122 and the radiation imaging unit 101 by rotating the supporting arm 121 counterclockwise about the rotation axis J2. As the supporting arm 121 rotates counterclockwise about the rotation axis J2, the radiation imaging unit 101 tilts such that the left end relative to the object P is positioned below the right end relative to the object P, as shown in FIG. 4B. The tilt detection unit 136 detects this tilt as tilt information and sends the detected tilt information to the rotation control unit 135. The rotation control unit 135 sends a driving signal, based on the tilt information, to the rotation driving unit 134 to rotate the radiation imaging unit 101 about the rotation axis J1 so as to position a narrow frame edge of the radiation imaging unit 101 at the left side (the side near the object P). In this embodiment, since the frame edge lengths at the side surfaces S1 and S2 are the same length, the rotation driving unit 134 may rotate the radiation imaging unit 101 counterclockwise through 90° when viewed from the incident surface side so as to position the surface S1 at the left side. Tilting and rotationally moving the radiation imaging unit 101 will locate the side surface S1 of the narrow frame edge of the radiation imaging unit 101 at a position near the object P (a position facing a direction corresponding to imaging conditions) (FIG. 4B). The rotation driving unit 134 needs to rotate the radiation imaging unit 101 while avoiding contact with the object P. More specifically, the tilt information detected by the tilt detection unit 136 is sent to the rotation control unit 135. In this case, the apparatus sets the radiation imaging unit 101 in the initial state (vertical state) by using the supporting arm 121. The apparatus then tilts the radiation imaging unit 101 by using the supporting arm 121 upon rotating the radiation imaging unit 101 by using the rotation driving unit 134 in accordance with the tilt information detected by the tilt detection unit 136. In this state, the apparatus moves the supporting arm 121 in the vertical direction by using the base portion 125 to adjust the position of the radiation imaging unit 101 relative to the object P, and then performs imaging.

In addition, when performing imaging operation upon sliding the supporting arm 121 in the C direction or performing imaging operation upon sliding the supporting arm 121 in the C direction in combination with rotationally moving it in the D direction, the tilt detection unit 136 detects the posture of the radiation imaging unit 101. The rotation control unit 135 then performs control to place a narrow frame edge of the radiation imaging unit 101 at a position near the object P (a position facing a direction corresponding to imaging conditions) in accordance with a detection result from the tilt detection unit 136.

Furthermore, it is possible to use an arrangement configured to calculate the posture of the radiation imaging unit 101 from the rotational movement amounts of the supporting arm 121 in the C and D directions instead of obtaining the posture by using the tilt detection unit 136 and use the calculated value for control.

As described above, the radiation imaging apparatus includes the radiation imaging unit 101 which has different frame edge widths from side surfaces to the imaging region, the rotation driving unit 134 which rotates the radiation imaging unit 101 about the rotation axis in a direction perpendicular to the imaging region, and the rotation control unit 135 which controls the rotation of the rotation driving unit 134 so as to place a side surface with a small frame edge width at a predetermined position in accordance with the position of the radiation imaging unit 101 or a method of imaging the object P. The predetermined position is the position at which a narrow frame edge is placed near the object P. In this manner, it is possible to place the imaging region A near the object P since the rotation of the radiation imaging unit 101 is controlled to place a narrow frame edge at a position nearest the object P (a position facing a direction corresponding to imaging conditions) in accordance with the posture of the radiation imaging unit 101.

In addition, when the radiation imaging unit 101 is placed slightly away from an object, a narrow frame edge can ensure a wider gap between the object and the radiation imaging unit. This can reduce an oppressive feeling for the object. According to the present invention, it is possible to easily perform imaging operation while orientating a narrow frame edge of the radiation imaging unit to a direction corresponding to imaging conditions.

In addition, a proximity detection unit (not shown) which detects that the object P has approached within a predetermined distance is provided in the housing 102 of the radiation imaging unit 101 and inputs a detection result to the rotation control unit 135. The rotation control unit 135 performs control to inhibit the radiation imaging unit 101 from rotating when it approaches within the predetermined distance relative to the object P. In this case, the rotation control unit 135 outputs a warning to notify the operator that the radiation imaging unit 101 has approached within the predetermined distance relative to the object P. The apparatus may also display the rotating direction of the radiation imaging unit 101 on a display unit (not shown). The apparatus may also display, on the display unit (not shown), the width (distance) by which a corner portion of the radiation imaging unit 101 protrudes as the radiation imaging unit 101 rotates. The operator can set the distance between the radiation imaging unit 101 and the object P in accordance with the width by which a corner portion of the radiation imaging unit 101 protrudes. As shown in FIG. 4B, the operator tilts the radiation imaging unit 101 such that the distance between the radiation imaging unit 101 and the object P becomes larger than the width by which a corner portion of the radiation imaging unit 101 protrudes.

In addition, since these operations are changed in synchronism with the posture of the radiation imaging unit, it is possible to perform imaging operation effectively using a narrow frame edge of the radiation imaging unit 101 while reducing the load on the operator.

### Second Embodiment

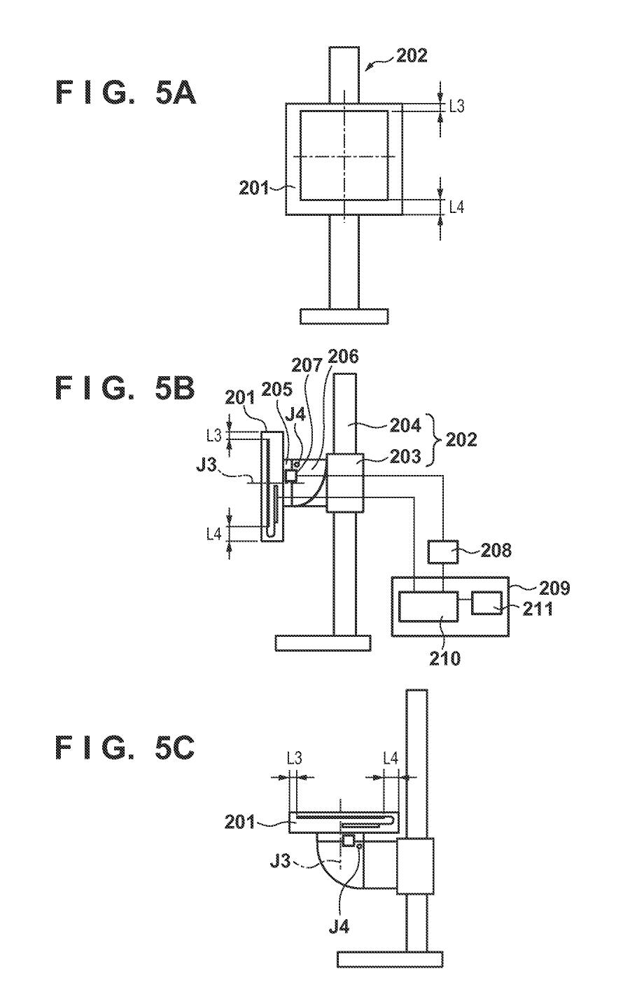

The arrangement and operation of a radiation imaging apparatus according to the second embodiment of the present invention will be described with reference to FIGS. 5A to 5C. The first embodiment has exemplified the arrangement configured to change the arrangement of narrow frame edges in accordance with the posture of the radiation imaging unit 101. The second embodiment will exemplify an arrangement configured to change the arrangement of narrow frame edges of a radiation imaging unit 201 based on imaging information associated with an imaging portion in an object P.

FIG. 5A is a view from the radiation incident direction. The radiation imaging unit 201 is mounted on an upright stand 202. FIG. 5B is a side view of FIG. 5A. The radiation imaging unit 201 has a narrow frame edge, which corresponds to a distance L3 from the side surface to the imaging region, located on the upper side, and a side surface having a frame edge length L4 longer than the length L3 and located on the lower side. The upright stand 202 includes a slider 203 and a column 204. The slider 203 has a slider function of vertically moving the column 204 and a lock function of fixing the column 204 at an arbitrary height. The connecting portion between the radiation imaging unit 201 and the slider 203 includes a rotating mechanical portion 205 which rotates the radiation imaging unit 201 about a rotation axis J3 and a tilt mechanical portion 206 which displaces the radiation imaging unit 201 to a horizontal state.

The rotating mechanical portion 205 incorporates a motor and a rotation driving unit 207 such as a driver which drives the motor. A rotation control unit 208 controls the rotation driving unit 207 to rotate and stop. The rotation control unit 208 is connected to an imaging control unit 210 in a console 209.

The console 209 includes the imaging control unit 210 including a CPU which controls the overall operation of the imaging apparatus and a ROM storing various types of programs including control programs, and an operation panel 211 which displays an operation menu and inputs an operation instruction with respect to each type of displayed information.

Information input by the operation panel 211 includes, for example, information of an imaging portion in an object. A selection menu including imaging portions such as a head portion, chest portion, abdominal portion, and lower extremity is prepared in advance. The imaging control unit 210 sets imaging conditions such as a tube voltage and tube current for radiation irradiation in accordance with input imaging portion information. When the operator selects an imaging portion in accordance with an imaging order, the imaging control unit 210 sets imaging conditions, thus simplifying setting operation.

At the same time, the imaging control unit 210 decides the position of a narrow frame edge of the radiation imaging unit 201 in accordance with the input imaging portion information, and sends a corresponding signal to the rotation control unit 208. The rotation control unit 208 drives the rotation driving unit 207 to set the narrow frame edge at a predetermined position, and then fix the position upon a predetermined amount of rotation.

For example, in chest radiography, the apparatus images an object up to the upper portions of the lung fields (lung apexes) upon placing a narrow frame edge on the upper side near an imaging portion in the object as a position facing a direction corresponding to imaging conditions. In contrast to this, in imaging an object in a sitting position or lower extremity imaging, it is possible to expand the imaging region on the lower side by placing a narrow frame edge on the lower side near the imaging portion in the object.

When performing imaging operation by using the tilt mechanical portion 206 upon setting the radiation imaging unit 201 in a horizontal state, the apparatus performs control to place the radiation imaging unit 201 so as to set a narrow frame edge on a side near the object (the narrow frame edge side, which corresponds to the distance L3 from the side surface of the housing to the imaging region, is on the left side), as shown in FIG. 5C. This allows the object to easily take an imaging posture.

Since the arrangement of a narrow frame edge of the radiation imaging unit 201 is automatically changed in accordance with imaging information, it is possible to perform imaging by effectively using a narrow frame edge of the radiation imaging unit 201 while reducing the load on the operator.

### Third Embodiment

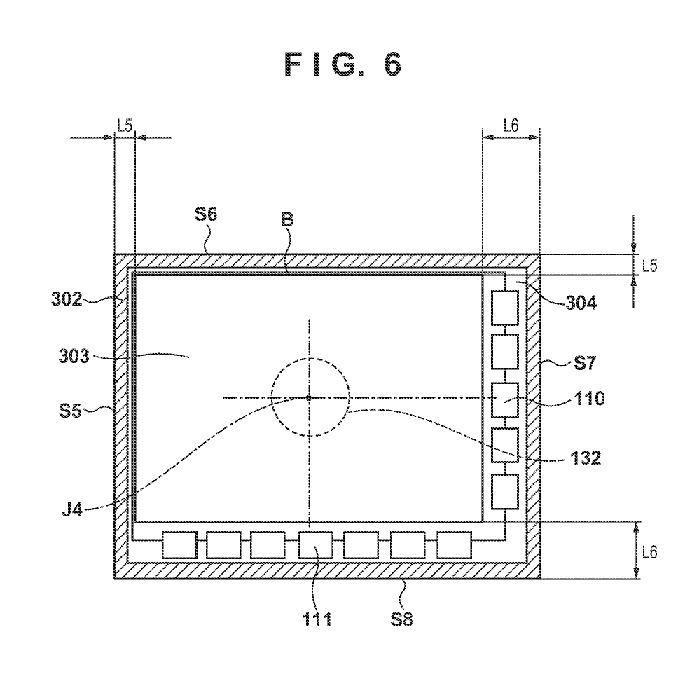

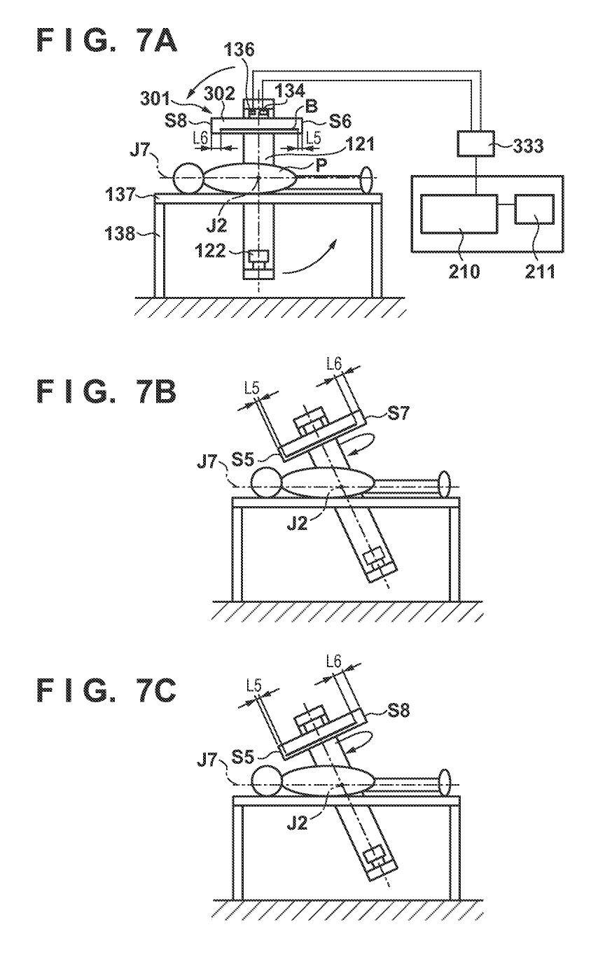

A radiation imaging apparatus according to the third embodiment of the present invention will be described with reference to FIGS. 6 and 7A to 7C. In the third embodiment, the apparatus controls the arrangement of a narrow frame edge of a radiation imaging unit, together with the posture of the radiation imaging unit, by using input imaging information.

Although the arrangement of the third embodiment is almost the same as that exemplified by the first embodiment, the third embodiment differs from the first embodiment in that the imaging region of the radiation imaging unit is rectangular (square in the first embodiment) as shown in FIG. 6 and imaging information is input to a rotation control unit as in the second embodiment. That is, the apparatus controls the arrangement of a narrow frame edge of the radiation imaging unit by using tilt information from a tilt detection unit 136 and information of an imaging portion in an object which is input via an operation panel 211.

Like FIG. 2, FIG. 6 is a view showing the internal structure of a radiation imaging unit 301 when viewed from a front side. An imaging region B of a radiation detection panel 303 has different adjacent sides, with long and short sides being respectively arranged in the horizontal and vertical directions. The connecting places of FPCs are set to the same positions as those in FIG. 2, and the four side surfaces of a housing 302 are respectively denoted by reference symbols S5 to S8. The frame edge lengths at the side surfaces S5 and S6 are a length L5, and the frame edge lengths at the side surfaces S7 and S8 are a length L6. Owing to the presence/absence of wiring spaces for connection electrode portions and FPCs, the relationship of L5<L6 holds concerning the frame edge lengths in the horizontal and vertical directions. That is, the distance (L5) from at least one side surface of the housing 302 to an imaging region B within a plane parallel to the imaging region B is shorter than the distance (L6) from another side surface of the housing 302 to the imaging region B.

The operation of each unit at the time of imaging will be described with reference to FIGS. 7A to 7C. The housing 302 of the radiation imaging unit 301 has a rectangular parallelepiped shape. In addition, a rotation control unit 333 receives information input from an imaging control unit 210, together with a signal from the tilt detection unit 136 (posture detection unit). The operation panel 211 is also connected to the imaging control unit 210. The imaging control unit 210 receives information of an imaging portion in an object via the operation panel 211.

Operation to change the arrangement to an arrangement configured to perform radiation irradiation from diagonally downward right as in FIGS. 4A and 4B will be described, with FIG. 7A showing an initial state. FIG. 7A shows a state in which a short side of the imaging region B is arranged in a direction along a body axis J7 of the object P on the right side of the side surface S6 (L5) which is a narrow frame edge of the radiation imaging unit 301. A supporting arm 121 is rotated counterclockwise about a rotation axis J2 in the state shown in FIG. 7A to tilt the radiation imaging unit 301 downward to the left. The tilt information detected by the tilt detection unit 136 is sent to the rotation control unit 333. The rotation control unit 333 performs rotation control to position the surface of a narrow frame edge of the radiation imaging unit 301 at a lower position. At this time, the rotation control unit 333 also refers to input information from the operation panel 211. Since the imaging region is rectangular, it is possible to select an arrangement suitable for imaging by using the operation panel 211. In addition, in this selection, arrangements may be set in correspondence with imaging portions to decide an arrangement in accordance with the selection of an imaging portion.

When a long side of the imaging region B is selected so as to be arranged along the body axis J7 of an object P, the rotation control unit 333 changes the arrangement to the state shown in FIG. 7B by rotating the radiation imaging unit 301 so as to set the side surface S5 on the left side. When a short side of the imaging region B is selected to be arranged along the body axis J7, the rotation control unit 333 changes the arrangement to the state shown in FIG. 7C by rotating the radiation imaging unit 301 to set the side surface S6 on the left side. The rotation control unit 333 determines, in accordance with the selection of an imaging portion, whether to arrange the side surface S5 or S6 on the left side, and rotates the radiation imaging unit 301 based on the determination result.

As described above, the apparatus arranges the imaging region B in a designated direction by using imaging information together with the posture (tilt information) of the radiation imaging unit 301, and arranges a side as a narrow frame edge of the radiation imaging unit.

### Fourth Embodiment

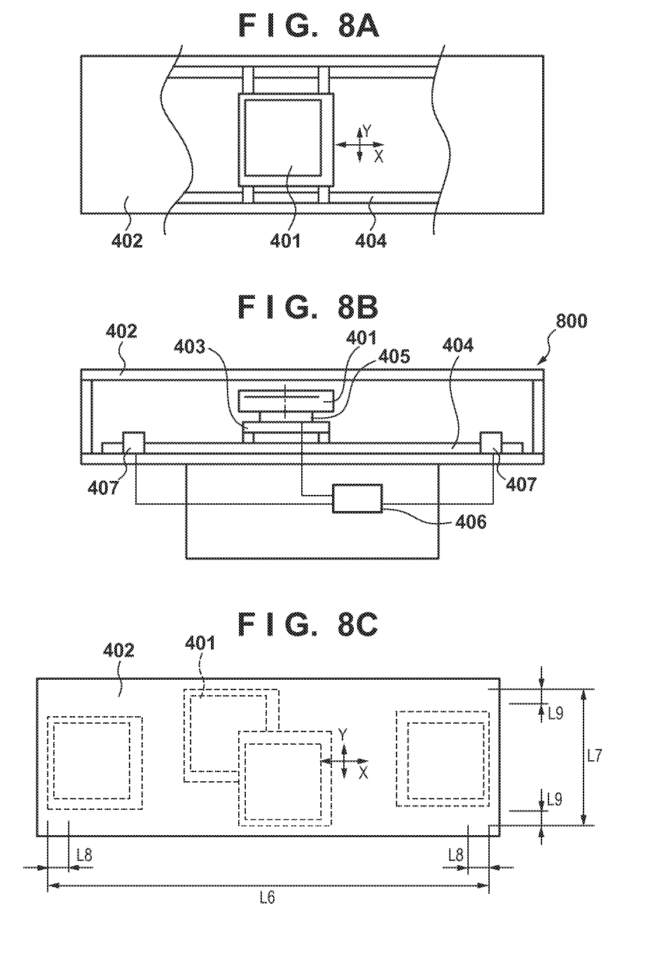

The arrangement and operation of a radiation imaging apparatus according to the fourth embodiment will be described with reference to FIGS. 8A to 8C. In the fourth embodiment, the apparatus controls the arrangement of a narrow frame edge in accordance with the position information of a radiation imaging unit in the horizontal direction.

FIG. 8A is a view showing a top 402 on which an object is placed, when viewed from above, and a state in which a radiation imaging unit 401 is held on an imaging base (holding member 800). FIG. 8B is a view when viewing FIG. 8A from a side. The radiation imaging unit 401 is mounted on a carriage 403 below the top 402. A driving mechanism (not shown) can move the carriage 403 to an arbitrary position in the horizontal direction by moving the carriage 403 on a rail 404 in the horizontal direction. A rotating mechanical unit 405 which rotates the radiation imaging unit is provided between the radiation imaging unit 401 and the carriage 403. The rotating mechanical unit 405 performs rotating operation in accordance with a signal from a rotation control unit 406.

FIG. 8C is a view for explaining the operation of relatively changing the arrangement of a narrow frame edge within a plane of the top 402 upon movement of the radiation imaging unit 401. In the movement of the radiation imaging unit 401 in the X direction, when the radiation imaging unit 401 is positioned within one of the ranges of distances L8 from the two sides of a total movement distance L6, the rotation control unit 406 controls the rotating mechanical unit 405 to direct a narrow frame edge of the radiation imaging unit outward. Likewise, in the movement of the radiation imaging unit 401 in the Y direction, when the radiation imaging unit 401 is positioned within one of the ranges of distances L9 from the two sides of a total movement distance L7, the rotation control unit 406 performs control to direct a narrow frame edge of the radiation imaging unit 401 outward. Note that a position detector 407 detects whether the radiation imaging unit exists in these regions, and inputs detected position information to the rotation control unit 406. The rotation control unit 406 controls the driving of the rotating mechanical unit 405 by using the input position information.

When performing imaging operation upon moving the radiation imaging unit 401, it is possible to expand the imaging region which can be covered by a radiation imaging unit having the same imaging region as much as possible by rotating the radiation imaging unit 401 to direct a narrow frame edge of the radiation imaging unit 401 outside within a plane of the top 402.

Each embodiment described above can provide an imaging technique which can facilitate imaging upon orientating a narrow frame edge of the radiation imaging unit to a direction corresponding to imaging conditions and can obtain an image corresponding to the imaging conditions.

Although the embodiments of the present invention have been described above, the present invention is not limited to the embodiments, and various modifications and changes can be made. The structure of the radiation panel has been exemplified as a factor that makes the distances from the imaging region of the radiation imaging unit to side surfaces of the housing differ from each other. However, similar effects can be obtained even when the distances from side surfaces differ from each other due to another structural factor.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-029436, filed Feb. 18, 2013, which is hereby incorporated by reference herein in its entirety.

What is claimed is:

1. A radiation imaging apparatus comprising:
a radiation imaging unit configured to have different frame edge widths from side surfaces to an imaging region;
a rotating unit configured to rotate said radiation imaging unit about a rotation axis in a direction perpendicular to the imaging region; and
a control unit configured to control rotation of said rotating unit so as to place a side surface at which the frame edge width is small at a predetermined position in accordance with a position of said radiation imaging unit.

2. A radiation imaging apparatus comprising:
a radiation imaging unit configured to have different frame edge widths from side surfaces to an imaging region;
a rotating unit configured to rotate said radiation imaging unit about a rotation axis in a direction perpendicular to the imaging region; and
a control unit configured to control rotation of said rotating unit so as to place a side surface at which the frame edge width is small at a predetermined position in accordance with an imaging method for the object.

3. A radiation imaging apparatus comprising:
a radiation imaging unit configured to include a housing and a detection unit having a rectangular imaging region, said detecting unit being placed at a position in said housing at which a distance from one side surface of said housing to the imaging region is shorter than a distance from another side surface to the imaging region;
a rotating unit configured to rotate said radiation imaging unit about a rotation axis in a direction intersecting with the imaging region; and
a control unit configured to control rotation of said rotating unit so as to orientate one side surface of said housing, a distance from which to the imaging region is short, to a direction corresponding to an imaging condition.

4. The apparatus according to claim 3, further comprising:
a supporting unit configured to support said radiation imaging unit;
a tilting unit configured to tilt said radiation imaging unit supported by said supporting unit relative to the object; and
a tilt detection unit configured to detect tilt information of said radiation imaging unit relative to the object as the imaging condition,
wherein said control unit controls rotation of said rotating unit by using the tilt information.

5. The apparatus according to claim 3, further comprising:
an input unit configured to input information of an imaging portion in an object as the imaging condition,
wherein said control unit controls rotation of said rotation unit by using the information of the imaging portion.

6. The apparatus according to claim 3, further comprising:
a tilt detection unit configured to detect tilt information of said radiation imaging unit relative to the object as the imaging condition,
an input unit configured to input information of an imaging portion in an object as the imaging condition,
wherein said control unit controls rotation of said rotation unit by using the tilt information and the information of the imaging portion in the object.

7. The apparatus according to claim 3, further comprising:
a holding unit configured to hold said radiation imaging unit within a plane parallel to the imaging region;
a moving unit configured to move said radiation imaging unit in a horizontal direction within the plane; and
a position detection unit configured to detect position information of said radiation imaging unit within the plane as the imaging condition,
wherein said control unit controls rotation of said rotating unit by using the position information.

8. A method of controlling a radiation imaging apparatus including a radiation imaging unit configured to have different frame edge widths from side surfaces to an imaging region, and a rotating unit configured to rotate the radiation imaging unit about a rotation axis in a direction perpendicular to the imaging region, the method comprising
a step of controlling rotation of the rotating unit so as to place a side surface at which the frame edge width is small at a predetermined position in accordance with a position of the radiation imaging unit or a method of imaging an object.
